(19) United States
(12) Patent Application Publication
(10) Pub. No.: US 2021/0028842 A1
(43) Pub. Date: Jan. 28, 2021

(54) METHOD AND APPARATUS FOR CHANNEL STATE INFORMATION FEEDBACK IN COMMUNICATION SYSTEM SUPPORTING SIDELINK COMMUNICATION

(71) Applicant: Electronics and Telecommunications Research Institute, Daejeon (KR)

(72) Inventors: Cheul Soon KIM, Daejeon (KR); Sung Hyun MOON, Daejeon (KR); Jung Hoon LEE, Daejeon (KR)

(73) Assignee: Electronics and Telecommunications Research Institute, Daejeon (KR)

(21) Appl. No.: 16/927,597

(22) Filed: Jul. 13, 2020

(30) Foreign Application Priority Data
Jul. 22, 2019 (KR) 10-2019-0088592
Jul. 3, 2020 (KR) 10-2020-0081915

(51) Int. Cl. H04B 7/06; H04W 4/06; H04L 1/18; H04L 5/00

(52) U.S. Cl. CPC H04B 7/0626; H04W 4/06; H04W 92/18; H04L 5/0051; H04L 1/1819

(57) ABSTRACT

Disclosed are CSI feedback methods and apparatuses in a communication system supporting sidelink communication. An operation method of a first terminal may comprise transmitting CSI request information for requesting transmission of a channel state information (CSI) report to a second terminal; receiving a CSI report #1 for a sidelink between the first terminal and the second terminal from the second terminal through a sidelink channel; and transmitting one or more CSI reports among the CSI report #1 and a CSI report #2 for a communication link between the first terminal and a base station to the base station through an uplink channel. Therefore, the performance of the communication system can be improved.

### CROSS-REFERENCE TO RELATED APPLICATIONS

This application claims priority to Korean Patent Applications No. 10-2019-0088592 filed on Jul. 22, 2019, and No. 10-2020-0081915 tiled on Jul. 3, 2020 with the Korean Intellectual Property Office (KIPO), the entire contents of which are hereby incorporated by reference.

### BACKGROUND

### 1. Technical Field

The present disclosure relates to a technique for sidelink communication in a communication system, and more specifically, to a technique for channel state information (CSI) feedback for sidelink communication.

### 2. Related Art

The communication system (hereinafter, a new radio (NR) communication system) using a higher frequency band (e.g., a frequency band of 6 GHz or higher) than a frequency band (e.g., a frequency band lower below 6 GHz) of the long term evolution (LTE) (or, LTE-A) is being considered for processing of soaring wireless data. The NR communication system may support not only a frequency band below 6 GHz but also 6 GHz or higher frequency band, and may support various communication services and scenarios as compared to the LTE communication system. For example, usage scenarios of the NR communication system may include enhanced mobile broadband (eMBB), ultra-reliable low-latency communication (URLLC), massive machine type communication (mMTC), and the like.

Meanwhile, the LTE communication system and the NR communication system may support vehicle-to-everything (V2X) communication, and the V2X communication may be performed according to a sidelink communication protocol. The sidelink communication for V2X may be performed based on a unicast scheme, a multicast scheme, a groupcast scheme, and/or a broadcast scheme. When the sidelink communication is performed based on the unicast scheme, a feedback method of a hybrid automatic repeat request (HARQ) response (e.g., HARQ-acknowledgement (ACK)) for sidelink communication, a channel state information (CSI) feedback method, or the like will be needed. However, in the NR communication system, the feedback method of the HARQ response and the CSI feedback method for the sidelink communication are not explicitly defined.

### SUMMARY

Accordingly, exemplary embodiments of the present disclosure provide methods and apparatuses for hybrid automatic repeat request (HARQ) response and channel state information (CSI) feedback in a communication system supporting sidelink communication.

According to a first exemplary embodiment of the present disclosure, an operation method of a first terminal in a communication system may comprise: transmitting CSI request information for requesting transmission of a channel state information (CSI) report to a second terminal; receiving a CSI report #1 for a sidelink between the first terminal and the second terminal from the second terminal through a sidelink channel; and transmitting one or more CSI reports among the CSI report #1 and a CSI report #2 for a communication link between the first terminal and a base station to the base station through an uplink channel.

A priority of the CSI report #1 may be determined according to a type of the sidelink channel through which the CSI report #1 is transmitted, and the sidelink channel may be a physical sidelink feedback channel (PSFCH) or a physical sidelink shared channel (PSSCH).

A priority of the CSI report #1 may be determined according to a transmission scheme of the CSI report #1, and the transmission scheme may be a trigger-based transmission scheme, a semi-persistent transmission scheme, or a periodic transmission scheme.

A priority of the CSI report #1 may be determined according to a sidelink communication scheme between the first terminal and the second terminal, and the sidelink communication scheme may be a unicast scheme, a groupcast scheme, or a broadcast scheme.

The one or more CSI reports may be selected according to a priority of the CSI report #1 and a priority of the CSI report #2, and the uplink channel ay be a physical uplink control channel (PUCCH) or a physical uplink shared channel (PUSCH).

A priority of the sidelink may be configured differently from a priority of the communication link, a priority of the CSI report #1 may be determined in consideration of the priority of the sidelink, and a priority of the CSI report #2 may be determined in consideration of the priority of the communication link.

When a cell index associated with the sidelink is same as a cell index associated with the communication link, a priority of the CSI report #1 and a priority of the CSI report #2 may be determined regardless of a priority between the sidelink and the communication link.

The operation method may further comprise transmitting data to the second terminal, wherein a hybrid automatic repeat request (HARQ) response for the data and the CSI report #1 are received through a same sidelink channel.

The CSI request information and scheduling information for the data may be included in sidelink control information (SCI) transmitted from the first terminal to the second terminal.

According to a second exemplary embodiment of the present disclosure, an operation method of a second terminal in a communication system may comprise: receiving a channel state information-reference signal (CSI-RS) from a first terminal through a sidelink between the first terminal and the second terminal; generating a plurality of CSI reports based on the CSI-RS; selecting one or more CSI reports according to priorities among the plurality of CSI reports; and transmitting the one or more CSI reports to the first terminal through a sidelink channel.

A priority of each of the plurality of CSI reports may be determined according to a type of the sidelink channel through which each of the plurality of CSI reports is transmitted, and the sidelink channel may be a physical sidelink feedback channel (PSFCH) or a physical sidelink shared channel (PSSCH).

A priority of each of the plurality of CSI reports may be determined according to a transmission scheme of each of the plurality of CSI reports, and the transmission scheme may be a trigger-based transmission scheme, a semi-persistent transmission scheme, or a periodic transmission scheme.

The priorities of the plurality of CSI reports may be determined according to a sidelink communication scheme between the first terminal and the second terminal, and the sidelink communication scheme may be a unicast scheme, a groupcast scheme, or a broadcast scheme.

The operation method may further comprise receiving sidelink control information (SCI) including scheduling information for data from the first terminal; and receiving the data from the first terminal based on the scheduling information, wherein a hybrid automatic repeat request (HARQ) response for the data and the CSI report #1 are transmitted through a same sidelink channel.

According to a third exemplary embodiment of the present disclosure, a first terminal in a communication system may comprise a processor; a memory electronically communicating with the processor; and instructions stored in the memory, wherein when executed by the processor, the instructions cause the first terminal to: transmit CSI request information for requesting transmission of a channel state information (CSI) report to a second terminal; receive a CSI report #1 for a sidelink between the first terminal and the second terminal from the second terminal through a sidelink channel; and transmit one or more CSI reports among the CSI report #1 and a CSI report #2 for a communication link between the first terminal and a base station to the base station through an uplink channel.

A priority of the CSI report #1 may be determined according to a type of the sidelink channel through which the CSI report #1 is transmitted, and the sidelink channel may be a physical sidelink feedback channel (PSFCH) or a physical sidelink shared channel (PSSCH).

A priority of the CSI report #1 may be determined according to a transmission scheme of the CSI report #1, and the transmission scheme may be a trigger-based transmission scheme, a semi-persistent transmission scheme, or a periodic transmission scheme.

A priority of the CSI report #1 may be determined according to a sidelink communication scheme between the first terminal and the second terminal, and the sidelink communication scheme may be a unicast scheme, a groupcast scheme, or a broadcast scheme.

The one or more CSI reports may be selected according to a priority of the CSI report #1 and a priority of the CSI report #2, and the uplink channel may be a physical uplink control channel (PUCCH) or a physical uplink shared channel (PUSCH).

A priority of the sidelink may be configured differently from a priority of the communication link, a priority of the CSI report #1 1 may be determined in consideration of the priority of the sidelink, and a priority of the CSI report #2 may be determined in consideration of the priority of the communication link.

According to the exemplary embodiments of the present disclosure, the transmitting terminal may transmit a channel state information-reference signal (CSI-RS) to the receiving terminal, and the receiving terminal may generate a plurality of CSI reports based on the CSI-RS. The receiving terminal may transmit to the transmitting terminal one or more CSI reports selected according to priorities of the plurality of CSI reports. The transmitting terminal may transmit one or more CSI reports selected according to priorities of CSI report(s) for the sidelink and CSI report(s) for downlink to the base station. Therefore, the CSI feedback for the sidelink can be efficiently performed, and the performance of the communication system can be improved.

### BRIEF DESCRIPTION OF DRAWINGS

Exemplary embodiments of the present disclosure will become more apparent by describing in detail embodiments of the present disclosure with reference to the accompanying drawings, in which:

FIG. 1 is a conceptual diagram illustrating a first exemplary embodiment of a communication system;

FIG. 2 is a block diagram illustrating a first exemplary embodiment of a communication node constituting a communication system;

FIG. 3 is a conceptual diagram illustrating a first exemplary embodiment of a communication system supporting sidelink communication; and

FIG. 4 is a sequence chart illustrating a first exemplary embodiment of a CSI feedback method in a communication system supporting sidelink communication.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part, by the particular intended application and use environment.

### DETAILED DESCRIPTION OF THE EMBODIMENTS

Embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication networks. Here, the communication system may be used in the same sense as a communication network.

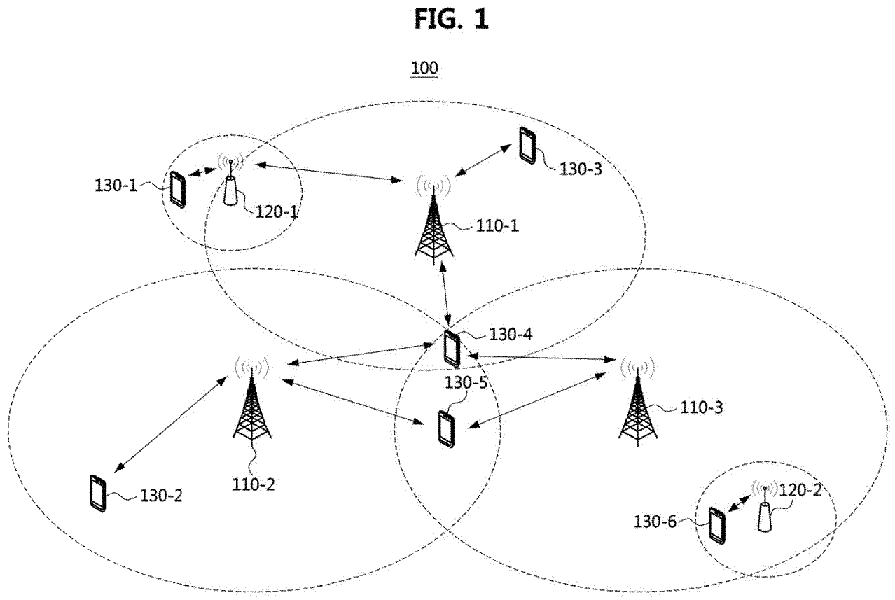

FIG. 1 is a conceptual diagram illustrating a first exemplary embodiment of a communication system.

Referring to FIG. 1, a communication network 100 may comprise a plurality of communication nodes 110-1, 110-2, 110-3, 120-1, 120-2, 130-1, 130-2, 130-3, 130-4, 130-5, and 130-6. The plurality of communication nodes may support 4th generation (4G) communication (e.g., long term evolution (LTE), LTE-advanced (LTE-A)), 5th generation (5G) communication (e.g., new radio (NR)), or the like. The 4G communication may be performed in a frequency band of 6 gigahertz (GHz) or below, and the 5G communication may be performed in a frequency band of 6 GHz or above.

For example, for the 4G and 5G communications, the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

Also, the communication network 100 may further include a core network. When the communication system 100 supports the 4G communication, the core network may comprise a serving gateway (S-GW), a packet data network (PDN) gateway (P-GW), a mobility management entity (MME), and the like. When the communication system 100 supports the 5G communication, the core network may comprise a user plane function (UPF), a session management function (SMF), an access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication network 100 may have the following structure.

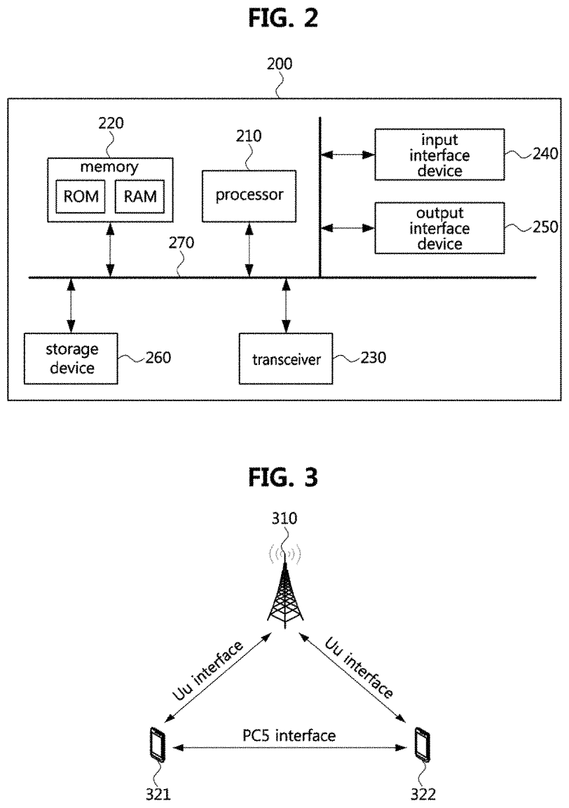

FIG. 2 is a block diagram illustrating a first embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication network 100 may comprise a plurality of base stations 110-1, 110-2, 110-3, 120-1, and 120-2, and a plurality of terminals 130-1, 130-2, 130-3, 130-4, 130-5, and 130-6. The communication network 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, a road side unit (RSU), a radio remote head (RRH), a transmission point (TP), a transmission and reception point (TRP), are eNB, a gNB, or the like. Each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, an Internet of things (IoT) device, a mounted apparatus (e.g., a mounted module/device/terminal or an on-board device/terminal, etc.), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Also, each of the plurality of base stations 110-1, 110-2, 110-3, 120-1, and 120-2 may support multi-input multi-output (MIMO) transmission (e.g., a single-user MIMO multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO mariner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for HARQ response and methods for transmitting a CSI report in a communication system supporting sidelink communication will be described. Even when a method (e.g., transmission or reception of a data packet) performed at a first communication node among communication nodes is described, the corresponding second communication node may perform a method (e.g., reception or transmission of the data packet) corresponding to the method performed at the first communication node. That is, when an operation of a terminal is described, the corresponding base station may perform an operation corresponding to the operation of the terminal. Conversely, when an operation of the base station is described, the corresponding terminal may perform an operation corresponding to the operation of the base station.

In the exemplary embodiments below, signaling may be performed through a combination of one or more among higher layer signaling, medium access control (MAC) signaling, and physical (PHY) signaling. The higher layer signaling may refer to a procedure for transmitting and receiving system information (e.g., master information block (MIB) or system information block (SIB)), and/or a radio resource control (RRC) message. The MAC signaling may refer to a procedure for transmitting and receiving a MAC control element (CE). The PHY signaling may refer to a procedure for transmitting and receiving control information (e.g., downlink control information (DCI), uplink control information (UCI), and sidelink control information (SCI)).

A message used for the higher layer signaling may be referred to as a higher layer signaling message, a message used for the MAC signaling may be referred to as a MAC signaling message, and a message used for the PHY signaling may be referred to as a PHY signaling message. In the exemplary embodiments below, the expression that a base station (e.g., serving base station) configures specific information to a terminal or that specific information is configured to a terminal may mean that the base station transmits a signaling message including the specific information to the terminal.

Channels used in sidelink communication may include a physical sidelink shared channel (PSSCH), a physical sidelink control channel (PSCCH), a physical sidelink discovery channel (PSDCH), a physical sidelink broadcast channel (PSBCH), and a physical sidelink feedback channel (PSFCH). A sidelink signal may be a synchronization signal and a reference signal used for sidelink communication. For example, the synchronization signal may be a synchronization signal/physical broadcast channel (SS/PBCH) block, a sidelink synchronization signal (SLSS), a primary sidelink synchronization signal (PSSS), or a secondary sidelink synchronization signal (SSSS). The reference signal may include a channel state information-reference signal (CSI-RS), a demodulation-reference signal (DM-RS), a phase tracking-reference signal (PT-RS), a cell-specific reference signal (CRS), and a sounding reference signal (SRS), or a discovery reference signal (DRS). In the exemplary embodiments below, the sidelink signal may be used as a meaning of including a sidelink signal and a sidelink channel.

FIG. 3 is a conceptual diagram illustrating a first exemplary embodiment of a communication system supporting sidelink communication.

Referring to FIG. 3, the communication system may include a base station 310, a first terminal 321, and a second terminal 322. The first terminal 321 and/or the second terminal 322 may be located within coverage of the base station 310. Alternatively, the first terminal 321 and/or the second terminal 322 may be located out of the coverage of the base station 310. The first terminal 321 and/or the second terminal 322 may be connected to the base station 310. Each of the first terminal 321 and the second terminal 322 may operate in a radio resource control (RRC) idle state, an RRC inactive state, or an RRC connected state. The base station 310, the first terminal 321, and the second terminal 322 may be configured to be the same as or similar to the communication node 200 shown in FIG. 2.

The vehicle-to-everything (V2X) communication service may be provided through a PC5 interface between the first terminal 321 and the second terminal 322 and/or a Uu interface between the base station 310 and the terminal (e.g., the first terminal 321 or the second terminal 322). The PC5 interface may be used for V2X sidelink (SL) communication. The V2X SL communication may mean V2X communication performed according to a sidelink communication scheme. In the exemplary embodiments below, the sidelink communication may mean the V2X SL communication. The V2X SL communication may be applied not only when the terminal (e.g., the first terminal 321 or the second terminal 322) belongs to the coverage of the base station 310, but also when the terminal (e.g., the first terminal 321 or the second terminal 322) does not belong to the coverage of the base station 310.

Meanwhile, a resource allocation operation for the V2X SL communication may be performed in two modes. When the first mode (hereinafter referred to as ‘mode 1’) is used, the terminal operating in the RRC connected state may request resource allocation from the base station (e.g., serving base station to which the terminal is connected), and the base station may transmit to the terminal information on resources allocated according to the request of the terminal, and the terminal may perform the V2X SL communication by using the resources allocated by the base station. When the second mode (hereinafter referred to as ‘mode 2’) is used, the terminal may autonomously secure a resource (e.g., sidelink resource). The sidelink resource may be a resource used for sidelink communication. The mode 2 may be used when a resource region or a resource pool is preconfigured to the terminal. In exemplary embodiments, the resource region may mean a resource pool, and the resource pool may mean a resource pool.

The terminal may perform a sensing operation (e.g., a listen-before-talk (LBT) operation) on sidelink resources, and select a specific sidelink resource according to a result of the sensing operation. The terminal may reselect the sidelink resource. Depending on the result of the sensing operation, a plurality of sidelink resources may be reserved. The number of sidelink resources that can be simultaneously reserved by the terminal may be limited. The maximum number of sidelink resources that can be simultaneously reserved by the terminal may be configured by a combination of one or more among higher layer signaling, MAC signaling, and PHY signaling. The terminal may perform sidelink communication (e.g., V2X SL communication) by using one or more sidelink resources among the plurality of reserved sidelink resources. One terminal may assist another terminal selecting a sidelink resource. Also, one terminal may directly allocate a sidelink resource to another terminal.

The terminal may report its geographic location information to the base station (e.g., serving base station). The geographic location information may be information (e.g., zone ID) indicating a zone to which the terminal belongs. The geographic location may be associated with a sidelink resource region (e.g., sidelink resource pool). The relationship (e.g., mapping relationship) between the geographic location and the sidelink resource region may be configured by one or more among higher layer signaling, MAC signaling, and PHY signaling. The relationship between the geographic location and the sidelink resource region may be used in the mode 2 (e.g., when the terminal autonomously selects the sidelink resource). The terminal located outside the coverage of the base station may use a preconfigured relationship (e.g., mapping relationship between the geographic location and the sidelink resource region).

The terminal may perform sidelink communication (e.g., V2X SL communication) in one or more carriers. The sidelink communication may be supported by networks (e.g., public land mobile networks (PLMNs)) of various operators. One or more SL semi-persistent scheduling (SPSs) may be configured, and one or more SL SPSs among a plurality of configured SL SPSs may be activated or deactivated. The SL SPS may be configured by the base station (e.g., serving base station) and/or terminal. The one or more SL SPSs may be configured by one or more combinations of higher layer signaling, MAC signaling, and PHY signaling. The base station (e.g., serving base station) may transmit information indicating activation or deactivation of the SL SPS to the terminal. The information indicating activation or deactivation of the SL SPS may be indicated by MAC signaling (e.g., MAC CE) and/or PHY signaling (e.g., DCI).

The terminal may transmit UE assistance information including other information (e.g., information for sidelink communication) to the base station (e.g., serving base station). The method of transmitting the UE assistance information may be configured by a combination of one or more among higher layer signaling. MAC signaling, and PHY signaling. The UE assistance information may include traffic characteristic information, and the traffic characteristic information may be used by the base station (e.g., serving base station) when activating the SL SPS. For example, the traffic characteristic information may include a SL SPS periodicity, a timing offset, a layer-2 (L2) ID of the receiving terminal (e.g., DUE) in sidelink communication, a logical channel identifier (LCID), the size (e.g., the maximum size) of a transport block, which is derived from the traffic pattern, and the like. The timing offset may be configured in units of a symbol(s), a slot(s), or a subframe(s). Here, the timing offset may be configured based on a system frame number (SFN) 0.

The sidelink resource region may be defined at one or more frequencies. Information on a sidelink resource region configured at a frequency other than a serving frequency may be broadcast from the base station through system information. Alternatively, the base station may transmit a separate message (e.g., a dedicated message, a UE-specific message) including the information on the sidelink resource region configured at a frequency other than the serving frequency to each terminal. Alternatively, the information on the sidelink resource region configured at a frequency other than the serving frequency may be preconfigured in the technical specification. That is, the information on the sidelink resource region configured at a frequency other than the serving frequency may be preconfigured to the terminal.

The base station may allocate sidelink resource(s) to the terminal. For example, the base station may configure one or more carriers to the terminal. Here, different carriers may be configured to the terminal. The base station may configure a different carrier(s) for each receiving terminal to a transmitting terminal (e.g., a source user equipment (SUE)). The different carrier(s) configured to the transmitting terminal may be used for data packet duplication. The transmitting terminal may be a terminal transmitting data (e.g. sidelink data), and the receiving terminal may be a terminal receiving the data.

Sidelink communication and uplink communication performed in the same frequency resource(s) may overlap in the time domain. In this case, the sidelink communication may be performed in preference to the uplink communication according to priorities thereof. Alternatively, the uplink communication may be performed in preference to the sidelink communication according to the priorities. The priorities may be configured to the terminal by a combination of one or more among higher layer signaling, MAC signaling, and PHY signaling. Alternatively, the priorities may be predefined in the technical specification. That is, the terminal may know the priorities in advance.

### CSI Feedback Multiplexing Method in Sidelink Communication

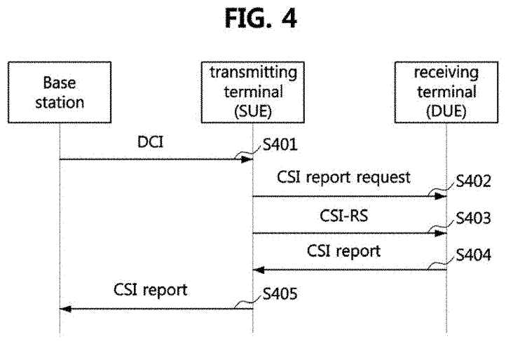

FIG. 4 is a sequence chart illustrating a first exemplary embodiment of a CSI feedback method in a communication system supporting sidelink communication.

Referring to FIG. 4, the communication system may include a base station, a transmitting terminal (i.e., source user equipment (SUE)), and a receiving terminal (i.e., destination user equipment (DUE)). The base station illustrated in FIG. 4 may be the base station 310 illustrated in FIG. 3, the transmitting terminal illustrated in FIG. 4 may be the first terminal 321 illustrated in FIG. 3, and the receiving terminal illustrated in FIG. 4 May be the second terminal 322 illustrated in FIG. 3. The base station, the first terminal, and the second terminal may be configured to be the same as or similar to the communication node 200 illustrated in FIG. 2.

The terminal may perform a measurement operation on a reference signal (e.g., CSI-RS) received from the base station and/or another terminal, and may feedback a CSI report that is a result of the measurement operation on the reference signal. For example, the terminal may transmit the CSI report to the base station (e.g., serving base station) through a physical uplink control channel (PUCCH) and/or a physical uplink shared channel (PUSCH). The terminal may transmit the CSI report to another terminal through a PSSCH and/or a PSCCH. The CSI report may mean a message, signal, or information including the CSI. The CSI may include one or more of a channel quality indicator (CQI), a preceding matrix indicator (PMI), and a rank indicator (RI). The CSI may further include other information as well as the CQI, PMI, and RI.

The base station (e.g., serving base station) may request transmission of a CSI report for sidelink communication to terminals (e.g., transmitting terminal and receiving terminal) performing the sidelink communication. The base station may request the transmitting terminal to transmit a CSI report for sidelink communication through a PDCCH to which a SL-DCI is mapped (S401). That is, information requesting the CSI report (hereinafter referred to as ‘CSI request information’) may be transmitted from the base station to the transmitting terminal through a PDCCH (e.g., SL-DCI). The SL-DCI may be a DCI including information for the sidelink communication, and the PDCCH to which the SL-DCI is mapped may be a PDCCH used for transmission of the SL-DCI.

The transmitting terminal may obtain the SL-DCI from the base station by performing a monitoring operation on the PDCCH, and may identify the CSI request information included in the SL-DCI. Alternatively, the CSI request information may be received through the PDCCH separately from the SL-DCI. That is, the CSI request information may not be included in the SL-DCI. The transmitting terminal may request the receiving terminal to transmit a CSI report for the sidelink communication through a PSCCH and/or a PSSCH to which a SCI is mapped (S402). The CSI request information may be included in the SCI. Alternatively, the CSI request information may be transmitted through the PSCCH and/or the PSSCH separately from the SCI. That is, the CSI request information may not be included in the SCI.

The SCI may include a ‘1st-stage SCI’ or ‘1st-stage SCI and 2nd-stage SCI’. The 1st-stage SCI may be transmitted through a PSCCH, and the 2nd-stage SCI may be transmitted through a PSSCH. The CSI request information may be included in the 1st-stage SCI and/or 2nd-stage SCI. The 1st-stage SCI may include one or more information elements among priority information, frequency resource assignment information, time resource assignment information, resource reservation period information, DMRS pattern information, 2nd-stage SCI format information, a beta offset indicator, the number of DMRS ports, and modulation and coding scheme (MCS) information.

The 2nd-stage SCI may include one or more information elements among an HARQ process identifier (ID), a redundancy version (RV), a source ID, a destination ID, CSI request information, a zone ID, and a communication range requirement. In addition, the SCI (e.g., 1st-stage SCI and/or 2nd-stage SCI) may further include information (e.g., frequency resource assignment information, time resource assignment information) indicating a PSFCH resource for HARQ feedback and/or information for transmission of the HARQ feedback.

Meanwhile, the receiving terminal may obtain the SCI from the transmitting terminal by performing a monitoring operation on the PSCCH and/or PSSCH, and may identify the CSI request information included in the SCI. Alternatively, the CSI request information may be received through the PSSCH and/or PSSCH separately from the SCI. The transmitting terminal may transmit a CSI-RS (e.g., CSI-RS for sidelink communication) to the receiving terminal (S403). When necessary, the transmitting terminal may transmit data (e.g., a sidelink shared channel (SL-SCH)) to the receiving terminal or other terminal(s). The data may be transmitted in a unicast scheme, a multicast scheme, a group cast scheme, or a broadcast scheme.

The receiving terminal may receive the CSI-RS from the transmitting terminal, and generate one or more CSI reports based on the received CSI-RS. The receiving terminal may transmit one or more CSI reports to the transmitting terminal (S404). When a plurality of CSI reports are generated for the sidelink, the receiving terminal may select one or more CSI reports (e.g., one or more CSI reports having a relatively higher priority) among the plurality of CSI reports according to priorities, and transmit the one or more selected CSI reports to the transmitting terminal. The priority of the CSI report may be determined based on Equation 1 or Equation 2 described below. The operation of determining the priority of the CSI report and the operation of selecting the CSI report based on the priority may be performed based on the exemplary embodiments described below. The CSI report(s) may be transmitted from the receiving terminal to the transmitting terminal using a PSSCH and/or a PSFCH. The PSSCH may be used for transmission of the CSI report(s). To support this operation, the transmitting terminal may transmit to the receiving terminal information on a PSSCH (e.g., a channel reserved by the transmitting terminal) to be used by the receiving terminal. Therefore, the receiving terminal may transmit the CSI report(s) to the transmitting terminal by using the PSSCH reserved by the transmitting terminal.

The transmitting terminal may receive the CSI report(s) for the sidelink from the receiving terminal. Also, the transmitting terminal may generate CSI report(s) based on a CSI-RS received from the base station. That is, CSI report(s) for a communication link (e.g., downlink) between the transmitting terminal and the base station may be generated. The transmitting terminal may select one or more CSI reports among the CSI report(s) for the communication link (e.g., downlink) and the CSI report(s) for the sidelink. The one or more CSI reports may be selected according to the priorities of the respective CSI reports. The priority of the CSI report may be determined based on Equation 1 or Equation 2 described below. The operation of determining the priority of the CSI report and the operation of selecting the CSI report based on the priority may be performed based on the exemplary embodiments described below.

The transmitting terminal may transmit the CSI report(s) to the base station by using a PUCCH and/or PUSCH (S405). The CSI report(s) transmitted in the step S405 may be the CSI report(s) selected by the transmitting terminal according to the priorities. For example, the CSI report(s) transmitted in the step S405 may include the CSI report(s) for the communication link and/or the CSI report(s) for the sidelink. The CSI report for the communication link may be a CSI report for the Uu interface between the base station and the transmitting terminal. The CSI report for the sidelink may be a CSI report for the PC5 interface between the transmitting terminal and the receiving terminal. The base station may receive the CSI report(s) from the transmitting terminal. The base station may support communication between the base station and the transmitting terminal and/or sidelink communication between the transmitting terminal and the receiving terminal, based on the CSI report(s).

### Periodical CSI Report Feedback Method Using SL SPS

When the size of the PSSCH is configured in advance, the transmitting terminal may transmit CSI request information to the receiving terminal according to an autonomous determination or determination of the base station (e.g., serving base station). Here, the CSI request information may request periodic CSI reporting. The receiving terminal may receive the CSI request information from the transmitting terminal, and may periodically transmit CSI report(s) to the transmitting terminal according to the CSI request information. Here, the CSI report(s) may be transmitted from the receiving terminal to the transmitting terminal through a PSFCH(s). When a SL SPS resource overlaps with a CSI resource, the CSI feedback operation may be performed according to a procedure defined in the technical specification. The SL SPS resource may be a resource configured according to a SL SPS, and the CSI resource may be a resource configured for transmission of the CSI report.

In a proposed method, when a priority of a SL-SCH (e.g., SL-SCH transmitted through the SL SPS resource) is higher than a priority of the CSI report, the SL-SCH may be transmitted instead of the CSI report in the overlapped resource between the SL SPS resource and the CSI resource.

In another proposed method, when the overlapped resource (e.g., time resource, slot) between the SL SPS resource and the CSI resource (e.g., resource for periodic CSI reporting) is preconfigured, the SL-SCH and the CSI report may be transmitted through the same PSSCH. In this case, the SL-SCI may be rate-matched in the PSSCH.

### CSI Report Priority Determination Method

One terminal may perform uplink communication or sidelink communication. In uplink communication or sidelink communication, the CSI report(s) may be transmitted along with other data. In this case, the terminal may select one or more CSI reports having a higher priority among the CSI report(s), and may map the selected one or more CSI reports to an uplink channel or a sidelink channel.

The base station (e.g., serving base station) may configure J PUCCH resources to the terminal by using higher layer signaling. For example, the base station may configure a multi-CSI-PUCCH-resource-list to the terminal. J may be an integer equal to or greater than 1. For example, the terminal may attempt to transmit a plurality of CSI reports through a PUCCH within one slot. In this case, the terminal may select one PUCCH resource among a PUCCH resource #0 to a PUCCH resource #J−1. The base station may define (e.g., configure) the PUCCH resources #0 to #J−1. In this case, the size of the PUCCH resource (e.g., the number of resource elements (RE)×coding rate×modulation order) may be defined to increase. Therefore, the size of PUCCH resource #1 may be larger than the size of PUCCH resource #0.

When other uplink control information (UCI(s)) and the CSI report(s) can be transmitted in the PUCCH resource #0, the terminal may transmit other UCI(s) and the CSI report(s) by using the PUCCH resource #0. The CSI report(s) may be encoded with other UCI(s). A cyclic redundancy check (CRC) may be added to the CSI report(s) and other UCI(s). The other UCI(s) may include a scheduling request (SR) and/or an HARQ response. The HARQ response may be referred to as ‘HARQ-ACK’, and may include acknowledgment (ACK) or negative ACK (NACK). When other UCI(s) and the CSI report(s) cannot be transmitted in the PUCCH resource #0, the terminal may use the PUCCH resource #1. That is, when other UCI(s) and the CSI report(s) can be transmitted in the PUCCH resource #1, the terminal may transmit other UCI(s) and the CSI report(s) by using the PUCCH resource #1.

When transmission of the CSI report(s) and other UCI(s) in the PUCCH resources #0 and 1 is impossible, one or more CSI reports among the CSI report(s) may not be transmitted. The one or more CSI reports excluded from transmission may be determined based on a predefined equation (e.g., priority). For example, the priority of each CSI report may be determined based on Equation 1 below.

pri(y,k,c,s)=2·N_{cells}·Mₛ·y+N_{cells}·Mₛ·k+·Mₛ·c+s [Equation 11]

N_{cells} may be indicated by signaling (e.g., higher layer signaling), and may mean the maximum number of serving cells. Mₛ may be indicated by signaling (e.g., higher layer signaling), and may mean the maximum number of CSI report configurations. y may indicate a CSI reporting scheme. If the CSI report is an aperiodic CSI report transmitted on a PUSCH, y may be set to 0. If the CSI report is a semi-static CSI report transmitted on a PUSCH, y may be set to 1. If the CSI report is a semi-static CSI report transmitted on a PUCCH, y may be set to 2. If the CSI report is a periodic CSI report transmitted on a PUCCH, y may be set to 3.

k may indicate the type of the CSI report. When the CSI report includes an reference signal received power (L1-RSRP), k may be set to 0. When the CSI report includes information other than L1-RSRP, k may be set to 1. c may indicate an index of the serving cell. s may indicate a CSI report index (e.g., CSI index). As pri(y,k,c,s) is smaller, the corresponding CSI report may be determined to have a higher priority.

Meanwhile, one or more CSI reports may be configured to be transmitted through a PUSCH. That is, y may be set to 0 or 1. In this case, transmissions of two CSI reports may collide with each other. For example, a CSI report #1 may be configured to be transmitted through a PUSCH, and a CSI report #2 may be configured to be transmitted through a PUSCH. One or more symbols included in the PUSCH configured for the CSI report #1 may overlap one or more symbols included in the PUSCH configured for the CSI report #2 in the time domain. In this case, the terminal may select a CSI report having a higher priority (e.g., smaller pri(y,k,c,s)) among the CSI report #1 and the CSI report #2, and may transmit the selected CSI report through the PUSCH.

In another exemplary embodiment, the CSI report #1 may be configured to be transmitted through a PUCCH, and the CSI report #2 may be configured to be transmitted through a PUSCH. One or more symbols included in the PUCCH configured for the CSI report #1 may overlap with one or more symbols included in the PUSCH configured for the CSI report #2 in the time domain. In this case, the terminal may not transmit a CSI report having a lower priority (e.g., larger pri(y,k,c,s)) among the CSI report #1 and the CSI report #2.

In another exemplary embodiment, one or more CSI reports may be configured to be transmitted through a PUCCH. That is, y may be set to 2 or 3. For example, the CSI report #1 may be configured to be transmitted through a PUCCH, and the CSI report #2 may be configured to be transmitted through a PUCCH. One or more symbols included in the PUCCH configured for the CSI report #1 may overlap one or more symbols included in the PUCCH configured for the CSI report #2 in the time domain. In this case, the terminal may not transmit a CSI report having a lower priority (e.g., larger pri(y,k,c,s)) among the CSI report #1 and the CSI report #2. That is, the terminal may select a CSI report having a higher priority (e.g., smaller pri(y,k,c,s)) among the CSI report #1 and the CSI report #2, and transmit the selected CSI report through the PUCCH. Here, one or more CSI reports may be selected, and the selected CSI report(s) may be multiplexed in the PUCCH. The PUCCH resource through which the selected CSI report(s) is transmitted may be the PUCCH resource #J−1.

The CSI report for the Uu interface (e.g., radio link between the base station and the terminal) may be measured in a downlink (DL) bandwidth part (BWP) or a DL carrier. The above-described CSI reporting scheme (e.g., CSI reporting scheme for the Uu interface) may be applied to the CSI reporting for the PC5 interface (e.g., sidelink between terminals). The CSI report for the PC5 interface may be measured in a SL BWP or a SL carrier.

Equation 1 (e.g., pri(y,k,c,s)) described above may be applied to a case where a receiving terminal transmits a CSI report to a transmitting terminal in sidelink communication and/or a case where a transmitting terminal performing sidelink communication, downlink communication, and/or uplink communication transmits a CSI report to a base station (e.g., serving base station).

### CSI Report Priority Determination Method in Sidelink Communication

The receiving terminal may transmit CSI report(s) to the transmitting terminal by using a PSFCH(s) and/or PSSCH(s). The receiving terminal may determine the priority of the CSI report by using Equation 1. That is, Equation 1 may be applied to a PC5 interface. However, the meaning of some element(s) in Equation 1 when applied to the PC5 interface may be different from the meaning of some element(s) in Equation 1 when applied to the Uu interface.

N_{cells} may be indicated by signaling (higher layer signaling), and may mean the maximum number of serving cells. Mₛ may be indicated by signaling (e.g., higher layer signaling), and may mean the maximum number of CSI configurations. y may indicate a CSI reporting scheme. When a CSI report for sidelink communication is triggered and the corresponding CSI report is transmitted through a PSSCH, y may be set to 0. That is, when the transmission scheme of the CSI report is a trigger-based transmission scheme, y may be set to 0. When the CSI report for sidelink communication is semi-statically activated and the corresponding CSI report is transmitted through a PSSCH, y may be set to 1. When the CSI report for sidelink communication is semi-statically activated, and the corresponding CSI report is transmitted through a PSFCH, y may be set to 2. That is, when the transmission scheme of the CSI report is a semi-persistent transmission scheme, y may be set to 1 or 2.

When the CSI report for sidelink communication is periodically transmitted through the PSFCH, y may be set to 3. That is, when the transmission scheme of the CSI report is a periodic transmission scheme, y may be set to 3. Periodic CSI report may not be defined in sidelink communication. In this case, the triggered CSI report may be transmitted through a PSSCH or PSFCH. Therefore, the value of y for sidelink communication may not be classified into four values. For example, the value of y for sidelink communication may be classified into two or three values. y may be used to distinguish a channel (e.g., PSFCH or PSSCH) through which a triggered CSI report is transmitted. Depending on the CSI reporting scheme, a channel (e.g., PSFCH or PSSCH) through which the CSI report can be transmitted may vary.

k may indicate the type of the CSI report. When the CSI report includes an L1-RSRP, k may be set to 0. When the CSI report includes information other than L1-RSRP, k may be set to 1. c may indicate a serving cell index. s may indicate a CSI report index (e.g., CSI index). As pri(y,k,c,s) is smaller, the corresponding CSI report may be determined to have a higher priority. The order of the important elements for determining the priority of the CSI report may be ‘CSI reporting scheme y→CSI type k→serving cell index c→CSI report index s’. That is, among the elements used to determine the priority of the CSI report, the importance of the CSI reporting scheme y may be the highest, and the importance of the CSI report index s may be the lowest.

Meanwhile, a sidelink resource region may be configured so that a PSSCH does not overlap with a PSFCH in the time domain. In this case, it may not be necessary to determine the priorities of the CSI reports. For example, a time resource region in which the PSSCH is transmitted may be configured to be always orthogonal to a time resource region in which the PSFCH is transmitted. However, transmission of the CSI report may be multiplexed in one physical channel (e.g., PSSCH) instead of two or more physical channels in the same slot. In this case, it is necessary to determine the priorities of CSI reports corresponding to different physical channels.

In a proposed method, a physical channel through which the CSI report is transmitted may be considered to determine the priority of the CSI report. The physical channel considered for the CSI reporting may be two physical channels (e.g., PSSCH, PSFCH). A first element indicating a physical channel through which the CSI report is transmitted may be configured. The first element set to a first value may indicate that the CSI report is transmitted using a PSSCH. The first element set to a second value may indicate that the CSI report is transmitted using a PSFCH.

The case when the CSI reporting is semi-statically activated may be distinguished from the case when the CSI reporting is triggered. In a proposed method, the CSI reporting scheme may be considered to determine the priority of CSI report. For example, the CSI reporting scheme may be classified into a trigger-based transmission scheme and a semi-static transmission scheme. Alternatively, the CSI reporting scheme may be classified into a trigger-based transmission scheme, a semi-static transmission scheme, and a periodic transmission scheme. The physical channel considered for the CSI reporting may be two physical channels (e.g., PSSCH, PSFCH). The first element described above may indicate the CSI reporting scheme as well as the physical channel through which the CSI report is transmitted.

The first element set to the first value may indicate that the CSI report is transmitted using a PSSCH. The first element set to the second value may indicate that the CSI report is transmitted using a PSFCH. The first element set to a third value may indicate that the triggered CSI report is transmitted using a PSSCH. That is, the first element set to the third value may indicate that the trigger-based transmission scheme is used. The first element set to a fourth value may indicate that the semi-statically activated CSI report is transmitted through a PSSCH. That is, the first element set to the fourth value may indicate that the semi-static transmission scheme is used. In this case, the CSI reporting scheme through the PSSCH may be classified into three types.

Meanwhile, the sidelink communication (e.g., PC5 interface) may support a unicast scheme, a multicast scheme, a groupcast scheme, and/or a broadcast scheme. A different priority may be assigned to each cast scheme for CSI report. To support this operation, the cast scheme may be reflected in a function for determining the priority of the CSI report.

In a proposed method, the cast scheme of the CSI report may be considered to determine the priority of the CSI report. In order to support this operation, when setting CSI report indexes (e.g., CSI indexes), the CSI report indexes may be sorted according to the cast schemes. For example, in Equation 1, s may denote the CSI report index. The CSI report index s may be assigned according to the priority of the cast scheme (e.g., unicast scheme, multicast scheme, groupcast scheme, broadcast scheme), and based on the corresponding CSI report index s, the priority of the CSI report may be determined.

However, additional signaling may be required to allocate new CSI report index(es) for sidelink communication. The reason is that when new CSI report index(es) are assigned, the existing CSI report index(es) should be reordered and the CSI reporting index(es) should be reconfigured to support this operation. A method requiring less signaling than signaling required for the method of determining the priority of CSI report using the CSI report index may be needed.

In a proposed method, in order to determine the priority of the CSI report, new element(s) indicating the cast scheme of the CSI report may be introduced. The priority of the CSI report may be determined according to a function, and a different priority may be assigned to each CSI report cast scheme. The CSI reporting according to the cast scheme may be performed in one serving cell. For example, the terminal may determine the priority of the CSI report based on Equation 2 below.

pri_{proposed(z,y,k,c,s)}=3·2·N_{cells}·Mₛ·z+2·N_{cells}·Mₛ·y+N_{cells}·Mₛ·k+·Mₛ·c+s [Equation 2]

N_{cells} may be indicated by signaling (e.g., higher layer signaling), and may mean the maximum number of serving cells. Mₛ may be indicated by signaling (e.g., higher layer signaling), and may mean the maximum number of CSI report configurations. y may indicate a CSI reporting scheme. k may indicate the type of the CSI report. s may indicate a CSI report index (e.g., CSI index).

In order to determine CSI report index(s) defined in the same serving cell, one or more step(s) may be added. The maximum number of CSI reports according to each cast scheme may be defined. For example, M_{sB} may indicate the maximum number of CSI reports transmitted according to the broadcast scheme, M_{sG} may indicate the maximum number of CSI reports transmitted according to the groupcast scheme. M_{sU} may indicate the maximum number of CSI reports transmitted according to the unicast scheme. The priority may be assigned to each cast scheme r. Here, the value of (M_{sB}+M_{sG}+M_{sU}) may not be greater than Mₛ. The CSI report index s may be extended to (r,s).

For example, when r (e.g., r=0) set to a first value indicates a broadcast scheme, (r,s) may be interpreted as s. When r (e.g., r=1) set to a second value indicates a groupcast scheme, (r,s) may be interpreted as ‘s+M_{sB}’. When r (e.g., r=3) set to a third value indicates a unicast scheme, (r,s) may be interpreted as ‘s+M_{sB}+M_{sG}’.

For another example, when r (e.g., r=0) set to the first value indicates a groupcast scheme, (r,s) may be interpreted as s. When r (e.g., r=1) set to the second value indicates a unicast scheme, (r,s) may be interpreted as ‘s+M_{sG}’. Here, the values of r (e.g., the first value, the second value, and the third value) may be set regardless of the sizes of the values. The priority of the CSI report may be calculated according to the function for determining the priority.

### CSI Report Priority Determination Method in Sidelink/Downlink/Uplink Communication

In order to determine the priority of the CSI report, the priority between sidelink communication, downlink communication, and uplink communication may be determined according to the interface (e.g., PC5 interface, Uu interface). Alternatively, the priority between sidelink communication, downlink communication, and uplink communication may be determined in consideration of other factor(s) as well as the interface (e.g., PC5 interface, Uu interface).

In a proposed method, the priority of the CSI report may be determined according to the interface (e.g., PC5 interface, Uu interface). For example, the priority of the CSI report for the PC5 interface (e.g., CSI report for sidelink) may be configured differently from the priority of the CSI report for the Uu interface (e.g., CSI report for downlink or uplink).

The terminal (e.g., transmitting terminal) may manage the PC5 interface and the Uu interface. Therefore, it may be preferable that the priority of the PC5 interface is configured differently from the priority of the Uu interface. To simplify the operation of the terminal (e.g., transmitting terminal), the priority of all CSI reports belonging to one interface may be higher than the priority of all CSI reports belonging to another interface.

When the terminal (e.g., transmitting terminal) operates in the mode 1, a link (e.g., downlink or uplink) between the transmitting terminal and the base station (e.g., serving base station) may be more important that a link (e.g., sidelink) between the transmitting terminal and the receiving terminal. Alternatively, the link (e.g., sidelink) between the transmitting terminal and the receiving terminal may be more important than the link (e.g., downlink or uplink) between the transmitting terminal and the base station (e.g., serving base station). In this case, emergency data and/or important data may be transmitted and received through the sidelink. The priorities between the links (e.g., interfaces) may be considered to determine the priority of the CSI report.

In a proposed method, a new element (z) indicating the interface (e.g., PC5 interface or Uu interface) related to the CSI report may be introduced into the function (e.g., Equation 2) for determining the priority of the CSI report. For example, z (e.g., z=0) set to a first value may indicate the Uu interface. z (e.g., z=1) set to a second value may indicate the PC5 interface. In pri_{proposed(z,y,k,c,s)} of Equation 2, the maximum value of y may be 3. The terminal (e.g., transmitting terminal) may appropriately determine the priority of the CSI report by changing the value of z in Equation 2.

In a proposed method, the priority of CSI report may be determined regardless of the interface (e.g., PC5 interface or Uu interface). In this case, the priority of the CSI report is determined regardless of the type of the interface, so that the function defined in the technical specification may be used to determine the priority of the CSI report. When the terminal (e.g., transmitting terminal) simultaneously supports the Uu interface and the PC5 interface, and the SL BWP and the UL BWP are configured (e.g., activated) in the same carrier, the serving cell index c may not be appropriately defined. The reason is that in the communication system supporting the frequency division duplexing (FDD) scheme, the serving cell index c of the DL BWP (e.g., DL carrier) is the same as the serving cell index c of the UL BWP (e.g., UL carrier).

Therefore, the priority of the CSI report derived by the transmitting terminal based on the CSI-RS received in the DL BWP (e.g., DL carrier) may not be distinguished from the priority of the CSI report derived by the receiving terminal based on the CSI-RS received in the SL BWP (e.g., SL carrier). The CSI report derived by the receiving terminal may be reported to the transmitting terminal, and the transmitting terminal may not distinguish the priority of the CSI report for the DL BWP and the priority of the CSI report for the SL BWP. Here, the SL BWP may be configured in the same carrier as the UL BWP associated with the DL BWP. To solve this problem, an index of the SL BWP (e.g., SL carrier) may be configured differently from an index of each of the DL BWP (e.g., DL carrier) and the UL BWP (e.g., UL carrier).

In a proposed method, a serving cell index for the DL BWP (e.g., DL carrier) or the UL BWP (e.g., UL carrier) ay be configured differently from a serving cell index for the SL BWP (e.g., SL carrier). In this case, the terminal (e.g., transmitting terminal) may know that the index of the SL BWP (e.g., SL carrier) associated with the CSI report for the sidelink communication is distinguished from the index of the DL BWP (e.g., DL carrier) associated with the CSI report for the downlink communication or the index of the UL BWP (e.g., UL carrier) associated with the CSI report for the uplink communication. To support this operation, the base station (e.g., serving base station) may determine priorities of the SL BWP (e.g., SL carrier), the DL BWP (e.g., DL carrier), the UL BWP (e.g., UL carrier). The determined priorities may be signaled from the base station to the terminal (e.g., transmitting terminal and receiving terminal).

### Method of Simultaneously Transmitting HARQ Response (e.g., HARQ-ACK) and CSI

The terminal (e.g., receiving terminal) may be configure to simultaneously transmit the HARQ response (e.g., HARQ-ACK bit) and the CSI report through the same channel (e.g., the same slot). The configuration of such the operation may be signaled by the base station and/or the transmitting terminal. When the HARQ response and the CSI report are transmitted in the same slot, a physical channel through which the HARQ response is transmitted in the same slot may be different from a physical channel through which the CSI report is transmitted in the same slot. In the same slot, the physical channel through which the HARQ response is transmitted may be multiplexed with the physical channel through which the CSI report is transmitted in the time domain or frequency domain. Whether to transmit the HARQ response and the CSI report in the same channel or the same slot may be determined according to the processing capability of the terminal (e.g., receiving terminal). Here, the processing capability of the terminal may include processing capability for decoding a DL-SCH or SL-SCH to derive the HARQ response(s) and/or processing capability for estimating a channel to derive the CSI report(s). The above-described operation(s) may not be allowed in the transmitting terminal.

When the Uu interface or the PC5 interface is supported, it may be determined whether to transmit the HARQ response and the CSI report in the same slot (or the same channel) according to the above-described processing capability. When both the PC5 interface and the Uu interface are supported, the first terminal (e.g., transmitting terminal) may forward the HARQ response(s) and/or CSI report(s) received from the second terminal (e.g., receiving terminal) to another communication node (e.g., base station). In this case, the first terminal may perform a relay function. The HARQ response(s) and CSI report(s) transmitted from the first terminal to another communication node include the HARQ response(s) and CSI report(s) of the second terminal as well as the HARQ response(s) and/or CSI report(s) of the first terminal.

For example, among the HARQ response(s) that the transmitting terminal transmits to the base station (e.g., serving base station), some HARQ response(s) may be result(s) of decoding SL-SCH(s) at the receiving terminal, and the remaining HARQ response(s) may be result(s) of decoding DL-SCH(s) at the transmitting terminal. Among the CSI report(s) that the transmitting terminal transmits to the base station (e.g., serving base station), some CSI report(s) may be result(s) of channel estimation based on the CSI-RS for sidelink communication at the receiving terminal, and the remaining CSI report(s) may be result(s) of channel estimation based on the CSI-RS for downlink communication and/or uplink communication at the transmitting terminal. The UCI (e.g., HARQ response, CSI report) of the transmitting terminal may be distinguished from the SL feedback information (e.g., HARQ response, CSI report) received from the receiving terminal. The processing power additionally required for the transmitting terminal for relaying the SL feedback information may not be large.

In a proposed method, the base station may configure the terminal (e.g., transmitting terminal and receiving terminal) to perform simultaneous transmission of the HARQ response and the CSI report by using higher layer signaling. The parameter indicating the simultaneous transmission of the HARQ response and the CSI report may be included in an RRC message. The parameter indicating the simultaneous transmission of the HARQ response and the CSI report, which is included in an RRC message for the Uu interface, may be different from the parameter indicating the simultaneous transmission of the HARQ response and the CSI report, which is included in an RRC message for the PC5 interface.

### Method of Transmitting CSI Report and/or HARQ Response Through PSFCH

In sidelink communication, each of the transmission of HARQ response and the transmission of CSI report may be activated or deactivated. In the exemplary embodiments below a case where both of the transmission of HARQ response and the transmission of CSI report for sidelink communication are activated may be considered.

The receiving terminal may receive a SL-SCH (e.g., sidelink data) from the transmitting terminal, perform a decoding operation on the SL-SCH, and generate an HARQ response (e.g., ACK or NACK) according to a result of the decoding operation. The receiving terminal may transmit the HARQ response to the transmitting terminal by using a PSFCH. The PSFCH used for transmission of the HARQ response may be indicated by a SCI or a preconfigured feedback timing. The SCI (e.g., 1st-stage SCI and/or 2nd-stage SCI) associated with scheduling information (e.g., resource allocation information) of the SL-SCH may include CSI request information.

The SCI may include time resource information (e.g., slot index, slot offset) of the PSSCH (or PSFCH) through which the CSI report is transmitted. Alternatively, the SCI may not include time resource information of the PSSCH (or PSFCH) through which the CSI report is transmitted. That is, the time resource information of the PSSCH (or PSFCH) through which the CSI report is transmitted may be indicated to the terminal (e.g., receiving terminal) explicitly or implicitly.

The HARQ response (e.g., HARQ-ACK bit) for the SL-SCH may be transmitted through the PSFCH. The SCI may include time resource information (e.g., slot index, slot offset) of the PSFCH through which the HARQ response is transmitted. Alternatively, the SCI may not include time resource information of the PSFCH through which the HARQ response is transmitted. That is, the time resource information of the PSFCH through which the HARQ response is transmitted may be indicated to the terminal (e.g., receiving terminal) explicitly or implicitly.

When the SCI indicates the time resource used for transmission of the CSI report in the transmission procedure of the CSI report for sidelink communication, the time resource for the CSI report indicated by the SCI may be the same as or different from the time resource of the PSFCH through which the HARQ response is transmitted. In sidelink communication, the resource for transmission of the HARQ response and/or the CSI report may be indicated explicitly or implicitly. Alternatively, the resource for transmission of the HARQ responses and/or the CSI report in sidelink communication may be defined in the technical specification. The HARQ response and the CSI report for sidelink communication may be fed back to the transmitting terminal through the same physical channel. Alternatively, the HARQ response and the CSI report for sidelink communication may be fed back to the transmitting terminal through different time resources. Here, the different time resources may belong to the same physical channel or different physical channels.

Meanwhile, the transmitting terminal may transmit to the receiving terminal information indicating that the CSI-RS periodically transmitted exists. This information may be transmitted by one or more combinations of higher layer signaling, MAC signaling, and PHY signaling (e.g., SCI). The receiving terminal may receive the periodic CSI-RS from the transmitting terminal, and generate CSI report(s) based on the periodic CSI-RS. The receiving terminal may transmit the CSI report(s) to the transmitting terminal by using PSSCH(s) and/or PSFCH(s). The resource (e.g., PSSCH, PSFCH) used for the transmission of the CSI report may be indicated when a request for the CSI report is configured. For example, the SCI may include information indicating the resource used for transmission of the CSI report as well as the CSI request information. Alternatively, the CSI report(s) may be multiplexed in another physical channel that the receiving terminal transmits to the transmitting terminal. The method of multiplexing the CSI report(s) may be predefined in the technical specification.

For example, the receiving terminal may periodically transmit the PSSCH to the transmitting terminal. When the periodic CSI report is indicated, and the periodicity of the PSSCH (e.g., periodicity and slot offset) coincides with the periodicity (e.g., periodicity and slot offset) of the CSI report, the receiving terminal may multiplex the CSI report and the SL-SCH in the PSSCH, and transmit the multiplexed CSI report and SL-SCH through the PSSCH. For another example, when there is no other physical channel transmitted from the receiving terminal to the transmitting terminal, the receiving terminal may transmit only the CSI report. In this case, the receiving terminal may transmit the CSI report to the transmitting terminal by using the PSFCH.

The PSFCH through which the CSI report is transmitted may consist of one or more symbols in the time domain. For example, the PSFCH may consist of 1 or 2 symbols in the time domain. The PSFCH may be a physical channel to which an encoded. CSI report or an encoded CSI report and HARQ response is mapped. For example, a PUCCH format 2 may be used.

In a proposed method, the CSI report may be transmitted on the PSFCH alone. The transmitting terminal may request transmission of the CSI report to the receiving terminal, and may transmit the CSI-RS. The receiving terminal may receive the CSI-RS from the transmitting terminal, and derive the CSI report(s) based on the received CSI-RS. The CSI-RS may be a periodic or aperiodic CSI-RS. When the CSI report is triggered, the transmitting terminal may transmit information indicating that the CSI-RS is transmitted together with the CSI request information to the receiving terminal. In this case, the resource used for transmission of the CSI report at the receiving terminal may be allocated or reserved by the transmitting terminal.

The resource available at the receiving terminal may be the PSSCH. For example, the resource used for the transmission of the CSI report the receiving terminal may be the PSSCH. When a specific mode of sidelink communication (e.g., a fourth sub-mode of the second mode in the NR communication system) is used, the transmitting terminal may allocate sidelink resource(s) to the receiving terminal. For example, the sidelink resource(s) may be allocated autonomously by the transmitting terminal. When a mode other than the specific mode is used in sidelink communication, the transmitting terminal may not be able to allocate sidelink resource(s) to the receiving terminal.

The receiving terminal may transmit the CSI report(s) to the transmitting terminal by using a resource (pre)configured for the receiving terminal or a resource indicated by the base station. When this operation is used, a time delay for CSI reporting may occur. Therefore, this operation may not be suitable in an environment in which fading of a radio channel is frequently changed.

The resource available at the receiving terminal may be the PSFCH. For example, the resource used for transmission of the CSI report at the receiving terminal may be the PSFCH. The transmitting terminal may transmit information indicating a PSFCH resource (e.g., resource index) to the receiving terminal. The information (e.g., resource index) indicating the PSFCH resource may be indicated to the receiving terminal through an implicit method, an explicit method, or a combination of the implicit method and the explicit method. The PSFCH may be supported in all modes for sidelink communication. The method of indicating the PSFCH resource may be simpler than the method of indicating the PSSCH resource. Therefore, the size of control information necessary to indicate the PSFCH resource may be smaller than the size of control information necessary to indicate the PSSCH resource.

In addition, the size of the CSI report for sidelink communication may be previously known to the transmitting terminal and the receiving terminal. Depending on a type of PMI codebook to be derived by the receiving terminal, the size of PMI (e.g., the number of bits constituting the PMI) may vary. Also, the size of the PMI and/or the size of the CQI may be affected by the size of the RI. Therefore, there may be a case where the exact size of the CSI report in the NR communication system is unknown. In particular, when the CSI report is transmitted through the PUCCH, the base station (e.g., serving base station) may perform a blind decoding operation to obtain the CSI report. However, since the number of CSI-RS antenna ports used in sidelink communication is small, the size of the CSI report may not be significantly changed by the size of the PMI.

The transmitting terminal may transmit the CSI request information to the receiving terminal, and the CSI report may be transmitted through the PSFCH. The physical channel used for the transmission of the CSI report may not be limited to the PSFCH. For example, the receiving terminal may transmit the CSI report(s) to the transmitting terminal by using the PSSCH and/or the PSFCH. This operation may be configured by the transmitting terminal.

In a proposed method, the physical channel (e.g., PSSCH and/or PSFCH) through which the CSI report is transmitted may be determined according to a SCI format. The transmitting terminal may transmit the SCI including scheduling information (e.g., resource allocation information) of the SL-SCH to the receiving terminal. Here, the SCI may be used to schedule the SL-SCH transmitted from the transmitting terminal to the receiving terminal. This SCI may be referred to as a ‘SCI format A’. Alternatively, the SCI may be used to schedule the SL-SCH transmitted from the receiving terminal to the transmitting terminal. That is, the above-described SCIs may have different formats. The SCI format A (e.g., 1st-stage SCI and/or 2nd-stage SCI of the SCI format A) may include the CSI request information. Alternatively, the SCI format B (e.g., 1st-stage SCI and/or 2nd-stage SCI of the SCI format B) may include the CSI request information.

In a proposed method, the CSI report may be concatenated with the HARQ response, and the concatenated CSI report and HARQ response may be transmitted through the PSFCH. The SCI (e.g., SCI format A and/or SCI format B) may include information indicating that the CSI report is transmitted through the PSFCH. The SCI format A may indicate the receiving terminal to perform the SL-SCH reception operation as well as the transmission operation of the CSI report. In this case, the receiving terminal may transmit an HARQ response (e.g., HARQ-ACK bit), which is a decoding result of the SL-SCH, through the PSFCH, and may transmit the CSI report(s) through the PSFCH. The PSFCH through which the HARQ response is transmitted may be the same as the PSFCH through which the CSI report(s) is transmitted. Alternatively, the PSFCH through which the HARQ response is transmitted may be different from the PSFCH through which the CSI report(s) is transmitted.

The receiving terminal may be configured to transmit the HARQ response and the CSI report through the same PSFCH. Alternatively, it may be defined in the technical standard that the receiving terminal transmits the HARQ response and the CSI report through the same PSFCH. In this case, the receiving terminal may simultaneously transmit the HARQ response and the CSI report through the same PSFCH.

Alternatively, the receiving terminal may be configured not to transmit HARQ response and the CSI report at the same time. For example, when the processing capability of the receiving terminal is insufficient, the receiving terminal may not complete the generation operation of the HARQ response and the generation operation of the CSI report the same time period (e.g., slot or mini-slot). In this case, the receiving terminal may transmit the HARQ response and the CSI report(s) through different PSFCHs. To support this operation, the SCI may include information indicating the PSFCH for transmission of the HARQ response and information indicating the PSFCH for transmission of the CSI report.

In order to reduce the size of the SCI (e.g., the number of bits constituting the SCI), it may be preferable to derive another PSFCH resource from one PSFCH resource. For example, the SCI may include a time offset (e.g., slot offset, mini-slot offset, symbol offset) between a specific PSFCH and another PSFCH. The specific PSFCH may be directly indicated by resource allocation information included in the SCI, and another PSFCH may be indicated by the resource allocation information and the time offset of the specific PSFCH. That is, the receiving terminal may identify a specific PSFCH (e.g., PSFCH for transmission of the HARQ response and/or the CSI report) based on the resource allocation information included in the SCI received from the transmitting terminal, and may identify another PSFCH by using the specific PSFCH and the time offset included in the SCI.

When the HARQ response and the CSI report are transmitted through the same PSFCH, a channel encoding operation for the HARQ response and the CSI report may be performed, and the encoded HARQ response and CSI report may be mapped to the PSFCH.

The channel encoding operation applied to the HARQ response may be different from the channel encoding operation applied to the CSI report. The reason is that an error rate required for the HARQ response may be different from an error rate required for the CSI report. The terminal (e.g., receiving terminal) may generate one codeword by performing the channel encoding operation on the HARQ response, and may generate one codeword by performing the channel encoding operation on the CSI report. The codeword for the HARQ response may be different from the codeword for the CSI report. The codeword for the HARQ response may be concatenated with the codeword for the CSI report, and the concatenated codewords may be mapped to the PSFCH. A coding rate applied to each of the HARQ response and the CSI report may be configured in advance. Alternatively, the SCI may include information (e.g., an index) indicating the coding rate applied to each of the HARQ response and the CSI report. The receiving terminal may identify the coding rate applied to each of the HARQ response and the CSI report based on the information included in the SCI received from the transmitting terminal.

The channel encoding operation applied to the HARQ response may be the same as the channel encoding operation applied to the CSI report. The HARQ response and the CSI report may be transmitted through the same PSFCH. The terminal (e.g., receiving terminal) may concatenate the HARQ response and the CSI report, and generate a codeword by performing the same channel encoding operation on the concatenated HARQ response and the CSI report. One codeword may be mapped to the PSFCH. The channel encoding operation may be performed using a Reed Muller code or a polar code. The coding rate applied to the PSFCH may be configured in advance. Alternatively, the SCI may include information (e.g., index) indicating the coding rate applied to the PSFCH. The receiving terminal may identify the coding rate applied to the PSFCH based on the information included in the SCI received from the transmitting terminal.

The exemplary embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

What is claimed is:

1. An operation method of a first terminal in a communication system, operation method comprising:
transmitting CSI request information for requesting transmission of a channel state information (CSI) report to a second terminal;
receiving a CSI report #1 for a sidelink between the first terminal and the second terminal from the second terminal through a sidelink channel; and
transmitting one or more CSI reports among the CSI report #1 and a CSI report #2 for a communication link between the first terminal and a base station to the base station through an uplink channel.

2. The operation method according to claim 1, wherein a priority of the CSI report #1 is determined according to a type of the sidelink channel through which the CSI report #1 is transmitted, and the sidelink channel is a physical sidelink feedback channel (PSFCH) or a physical sidelink shared channel (PSSCH).

3. The operation method according to claim 1, wherein a priority of the CSI report #1 is determined according to a transmission scheme of the CSI report #1, and the transmission scheme is a trigger-based transmission scheme, a semi-persistent transmission scheme, or a periodic transmission scheme.

4. The operation method according to claim 1, wherein a priority of the CSI report #1 is determined according to a sidelink communication scheme between the first terminal and the second terminal, and the sidelink communication scheme is a unicast scheme, a groupcast scheme, or a broadcast scheme.

5. The operation method according to claim 1, wherein the one or more CSI reports are selected according to a priority of the CSI report #1 and a priority of the CSI report #2, and the uplink channel is a physical uplink control channel (PUCCH) or a physical uplink shared channel (PUSCH).

6. The operation method according to claim 1, wherein a priority of the sidelink is configured differently from a priority of the communication link, a priority of the CSI report #1 is determined in consideration of the priority of the sidelink, and a priority of the CSI report #2 is determined in consideration of the priority of the communication link.

7. The operation method according to claim 1, wherein when a cell index associated with the sidelink is same as a cell index associated with the communication link, a priority of the CSI report #1 and a priority of the CSI report #2 are determined regardless of a priority between the sidelink and the communication link.

8. The operation method according to claim 1, further comprising transmitting data to the second terminal, wherein a hybrid automatic repeat request (HARQ) response for the data and the CSI report #1 are received through a same sidelink channel.

9. The operation method according to claim 8, wherein the CSI request information and scheduling information for the data are included in sidelink control information (SCI) transmitted from the first terminal to the second terminal.

10. An operation method of a second terminal in a communication system, the operation method comprising:
receiving a channel state information-reference signal (CSI-RS) from a first terminal through a sidelink between the first terminal and the second terminal;
generating a plurality of CSI reports based on the CSI-RS;
selecting one or more CSI reports according to priorities among the plurality of CSI reports; and
transmitting the one or more CSI reports to the first terminal through a sidelink channel.

11. The operation method according to claim 10, wherein a priority of each of the plurality of CSI reports is determined according to a type of the sidelink channel through which each of the plurality of CSI reports is transmitted, and the sidelink channel is a physical sidelink feedback channel (PSFCH) or a physical sidelink shared channel (PSSCH).

12. The operation method according to claim 10, wherein a priority of each of the plurality of CSI reports is determined according to a transmission scheme of each of the plurality of CSI reports, and the transmission scheme is a trigger-based transmission scheme, a semi-persistent transmission scheme, or a periodic transmission scheme.

13. The operation method according to claim 10, wherein the priorities of the plurality of CSI reports are determined according to a sidelink communication scheme between the first terminal and the second terminal, and the sidelink communication scheme is a unicast scheme, a groupcast scheme, or a broadcast scheme.

14. The operation method according to claim 10, further comprising:
receiving sidelink control information (SCI) including scheduling information for data from the first terminal; and
receiving the data from the first terminal based on the scheduling information,
wherein a hybrid automatic repeat request (HARQ) response for the data and the CSI report #1 are transmitted through a same sidelink channel.

15. A first terminal a communication system, the first terminal comprising:
a processor;
a memory electronically communicating with the processor; and
instructions stored in the memory,
wherein when executed by the processor, the instructions cause the first terminal to:
transmit CSI request information for requesting transmission of a channel state information (CSI) report to a second terminal;
receive a CSI report #1 for a sidelink between the first terminal and the second terminal from the second terminal through a sidelink channel; and
transmit one or more CSI reports among the CSI report #1 and a CSI report #2 for a communication link between the first terminal and a base station to the base station through an uplink channel.

16. The first terminal according to claim 15, wherein a priority of the CSI report #1 is determined according to a type of the sidelink channel through which the CSI report #1 is transmitted, and the sidelink channel is a physical sidelink feedback channel (PSFCH) or a physical sidelink shared channel (PSSCH).

17. The first terminal according to claim 15, wherein a priority of the CSI report #1 is determined according to a transmission scheme of the CSI report #1, and the transmission scheme is a trigger-based transmission scheme, a semi-persistent transmission scheme, or a periodic transmission scheme.

18. The first terminal according to claim 15, wherein a priority of the CSI report #1 is determined according to a sidelink communication scheme between the first terminal and the second terminal, and the sidelink communication scheme is a unicast scheme, a groupcast scheme, or a broadcast scheme.

19. The first terminal according to claim 15, wherein the one or more CSI reports are selected according to a priority of the CSI report #1 and a priority of the CSI report #2, and the uplink channel is a physical uplink control channel (PUCCH) or a physical uplink shared channel (PUSCH).

20. The first terminal according to claim 15, wherein a priority of the sidelink is configured differently from a priority of the communication link, a priority of the CSI report #1 is determined in consideration of the priority of the sidelink, and a priority of the CSI report #2 is determined in consideration of the priority of the communication link.
